(19) United States
(12) Patent Application Publication
(10) Pub. No.: US 2022/0071104 A1
(43) Pub. Date: Mar. 10, 2022

(54) TOTEM PLANT SUPPORT

(71) Applicants: Ray M Cheng, Santa Ana, CA (US); Kenneth Scott Bower, Santa Ana, CA (US)

(72) Inventors: Ray M Cheng, Santa Ana, CA (US); Kenneth Scott Bower, Santa Ana, CA (US)

(21) Appl. No.: 17/472,471

(22) Filed: Sep. 10, 2021

Related U.S. Application Data
(60) Provisional application No. 63/076,387, filed on Sep. 10, 2020.

(51) Int. Cl. A01G 9/12; F16B 7/02; F16B 7/18

(52) U.S. Cl. CPC A01G 9/122; F16B 7/182; F16B 7/02

(57) ABSTRACT

Disclosed are example embodiments of a sectional interlocking plant support system providing a stand for supporting growing plants in soil comprising a stake and a pole, coupled to the stake or other devices, the pole comprising a porous tubular body, the porous tubular body formed by a plurality of porous openings on the pole, the pole configured to be stackable on a second pole, the height being adjustable be selecting a number of poles to connect together. The porous openings on the pole comprising at least one hole shaped in at least one of a circle, a triangle, a square, a hexagon, a pentagon, a heptagon, an octagon, a nonagon, a polygon having more than nine sides, or a irregular shape.

### CROSS-REFERENCE TO RELATED APPLICATION

The present application claims priority to U.S. Provisional Patent Application Ser. No. 63/076,387, filed on Sep. 10, 2021, which is hereby incorporated by reference.

### TECHNICAL FIELD

The disclosure relates generally to the field of gardening, including both indoor gardening and outdoor gardening, specifically and not by way of limitation, some embodiments are related to plant supports.

### BACKGROUND

Gardeners, including plant collectors and enthusiasts, may attempt to provide support for plants during all stages of plant growth. There are many known examples of plant support systems. For example, gardeners, plant collectors and enthusiasts may utilize one or more sticks, stakes, rods, another solid shaft, or other support structure. The sticks, stakes, rods, or other solid shafts may be driven into the ground, substrate, planter, pot, or other container near the plant. Additionally, several flexible support bands or straps may be wrapped around the plant and secured to the stick, stake, rod, shaft, or other support structure. A stick, stake, rod, solid shaft, or other support structure may be used as a plant support. However, such a support is not a visually appealing support, cannot easily be stacked for greater height, and has a generally solid surface that is not porous. Accordingly, the use of a stick, rod, or solid shaft has disadvantages.

Staking a plant to support it is time-consuming. For example, it takes time to wrap bands or straps securing the plant to the stake. Additionally, the material used to wrap the plant may rub against and damage the plant. The strap that may be connected to a stake may also slide down the stake. This may allow or cause the plant to collapse upon itself. Additionally, a non-porous material may not be as useful for providing water, humidity, or other nutrients to the plant.

Accordingly, it may be advantageous to have interlocking, stackable poles for a more stable link for height, breathable holes or openings on the pole to allow air roots to grasp the support system, and a more functional stake design allowing better stability and appearance. The breathable holes may also allow for the use of supports that are less likely to slide down the pole by giving the supports a location to snap into or otherwise connect with. Additionally, a porous material may be more useful for providing water, humidity, or other nutrients to the plant.

### SUMMARY

Disclosed are systems and methods for a sectional interlocking plant support system that provides a stand for supporting growing plants in a substrate.

One general aspect includes a sectional interlocking plant support system providing a stand for supporting growing plants in substrate. The sectional interlocking plant support system also includes a stake. The system also includes a pole coupled to the stake; the pole may include a porous tubular body, the porous tubular body formed by a plurality of porous openings on the pole, the pole configured to be stackable on another pole, height of the sectional interlocking plant support system being adjustable by connecting a number of poles together.

One general aspect includes a method of forming a sectional interlocking plant support system. The method also includes forming a stake of the sectional interlocking plant support system, forming a pole of the sectional interlocking plant support system. Forming the pole includes forming a tubular body and forming a plurality of porous openings on the tubular body. Additionally, the method includes coupling, e.g., interlocking, joining, linking, connecting, engaging, etc., the pole to the stake, e.g., using an interlocking mechanism, or mid-flange.

The features and advantages described in the specification are not all-inclusive. In particular, many additional features and advantages will be apparent to one of ordinary skill in the art in view of the drawings, specification, and claims. Moreover, it should be noted that the language used in the specification has been principally selected for readability and instructional purposes and may not have been selected to delineate or circumscribe the disclosed subject matter.

### BRIEF DESCRIPTION OF THE DRAWINGS

The foregoing summary, as well as the following detailed description, is better understood when read in conjunction with the accompanying drawings. The accompanying drawings, which are incorporated herein and form part of the specification, illustrate a plurality of embodiments and, together with the description, further serve to explain the principles involved and to enable a person skilled in the relevant art(s) to make and use the disclosed technologies.

FIG. 1 is a diagram illustrating a front view of an example assembled stake and one pole.

FIG. 2 is a diagram illustrating a perspective view of the example assembled stake and pole of FIG. 1.

FIG. 3 is a diagram illustrating a perspective view of the example assembled stake and pole of FIG. 1, further illustrating an interior for moss.

FIG. 4 is a diagram illustrating a front view of the example assembled stake and pole of FIG. 1, further illustrating the pole connecting to the stake.

FIG. 5 is a diagram illustrating a front view of the example assembled stake and pole of FIG. 1, further illustrating the pole interlocking with a stake.

FIG. 6 is a diagram illustrating a section view of the example assembled stake and pole of FIG. 1, further illustrating a connection and interlocking mechanism.

FIG. 7 is a diagram illustrating a top view of the example assembled stake and pole of FIG. 1, further illustrating a view of the interior area and a drainage feature.

FIG. 8 is a flow diagram illustrating an example method in accordance with the systems and methods described herein.

FIG. 9 is a diagram illustrating example pole shapes.

FIG. 10 is a diagram illustrating example air hole shapes for an example pole.

FIG. 11 is a diagram illustrating an example locking mechanism for the systems and methods described herein.

FIG. 12 is a diagram illustrating an example locking mechanism for the systems and methods described herein.

FIG. 13 is a diagram illustrating an example pole clip for the systems and methods described herein.

FIG. 14 is another diagram illustrating an example pole clip for the systems and methods described herein.

FIG. 15 is a diagram illustrating an example branch brace in accordance with the systems and methods described herein.

FIG. 16 is a diagram illustrating an example support extender in accordance with the systems and methods described herein.

FIG. 17 is a diagram illustrating an example cap in accordance with the systems and methods described herein.

FIG. 18 is a diagram illustrating the example assembled stake and one pole of FIGS. 1-7 and the cap of FIG. 17, with the cap installed.

FIG. 19 is a diagram illustrating a stake and two poles.

FIG. 20 is a diagram illustrating a wicking material or fertilizer in a pole.

The figures and the following description describe certain embodiments by way of illustration only. One skilled in the art will readily recognize from the following description that alternative embodiments of the structures and methods illustrated herein may be employed without departing from the principles described herein. Reference will now be made in detail to several embodiments, examples of which are illustrated in the accompanying figures. It is noted that wherever practicable similar or like reference numbers may be used in the figures to indicate similar or like functionality.

### DETAILED DESCRIPTION

The detailed description set forth below in connection with the appended drawings is intended as a description of configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well-known structures and components are shown in block diagram form in order to avoid obscuring such concepts.

In view of the foregoing disadvantages in the known types of plant support systems now present in the indoor/outdoor plant industry, some embodiments of the devices, systems, and methods described herein may provide a plant support system. The plant support system may allow for internal filling of sphagnum moss and other substrates rather than wrapping the sphagnum moss and other substrates around a central pole. Additionally, the plant support system may be more visually appealing compared to current plant support systems.

Some embodiments may provide a new support system that allows for one or more of the following features, a visually appealing support, interlocking, stackable poles for a more stable link for height, breathable holes on the pole to allow air roots to grasp the support system, and a more functional stake design allowing better stability. Other plant support systems and moss poles, in particular, do not allow for such support. As discussed above, it may be advantageous to have interlocking, stackable poles with breathable holes or openings. The breathable holes may include a porous material that may be more useful for providing water, humidity, or other nutrients to the plant.

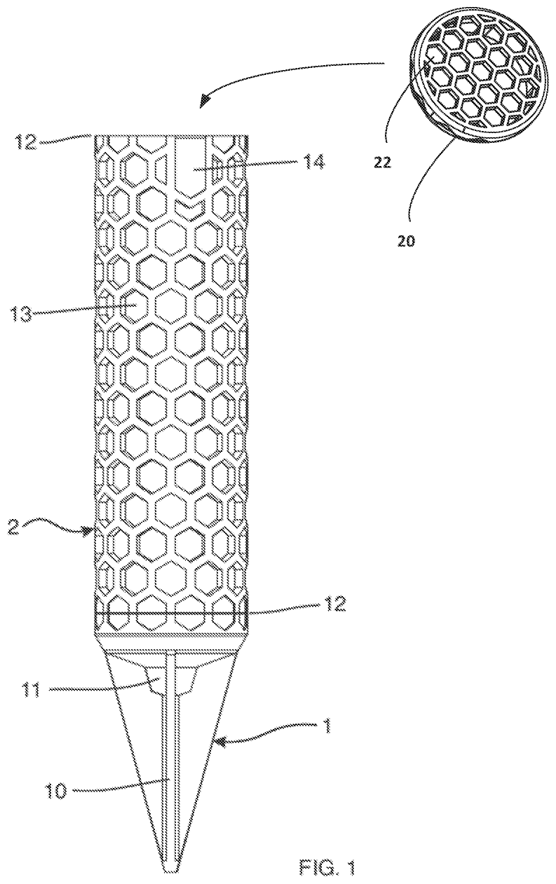

FIG. 1 is a diagram illustrating a front view of an example of an assembled base stake 1 and one plant support pole 2. An example embodiment may include a base stake 1 (e.g., cross-shaped). The base stake 1 may include a large surface area compared to the size of the plant support pole 2, as compared to comparably sized support poles. The large surface area may increase the stability of the plant support pole 2. The plant support pole 2 may include a porous body having porous openings 13 on the pole for airflow and roots to attach. The plant support pole 2 may include a cylindrical body allowing for airflow for air roots to attach. The plant support pole 2 may also include an interlocking mechanism 16 to allow each segment to be locked in for stability. The plant support pole 2 may also have different shaped holes, e.g., a hexagon, on the body for a more appealing look. While the illustrated embodiment may include holes in the shape of a hexagon, it will be understood that other shaped holes may also be used. For example, some embodiments may use one or more of the following shapes, circles, triangles, squares, pentagon, heptagon, octagon, nonagon, or a polygon having even more sides. In some embodiments, irregular shapes may be used. It will also be understood that shapes may vary on the plant support pole 2. For example, holes may be interrupted or partially interrupted by branding locations 14 or other variations in the plant support pole 2.

In this respect, before explaining at least one embodiment of the invention in detail, it is to be understood that the invention is not limited in its application to the details of construction and to the arrangements of the components set forth in the following description or illustrated in the drawings. The invention is capable of other functions and of being practiced and carried out in various ways. Also, it is to be understood that the phraseology and terminology employed are for the purpose of the description and should not be regarded as limiting.

A primary object of the present invention is to provide a support system that will overcome the shortcomings of the prior devices.

The figures and the following description describe certain embodiments by way of illustration only. One skilled in the art will readily recognize from the following description that alternative embodiments of the structures and methods illustrated herein may be employed without departing from the principles described herein. Reference will now be made in detail to several embodiments, examples of which are illustrated in the accompanying figures. It is noted that wherever practicable similar or like reference numbers may be used in the figures to indicate similar or like functionality.

The front view, FIG. 1, illustrates an assembly of one stake and one pole. This assembly is constructed from plastic but could also be of other materials such as wood, pulp, or cast materials. The product can be of many colors. The base stake 1 is used to secure the Totem assembly in a substrate such as potting soil with better stability. The base stake 1 contains ribs 10, which add greater surface area, pierce into the substrate and provide stability to the Totem as plant support poles 2 are added to increase the height of the Totem assembly. The stake also acts as an end cap to contain the pole's internal filling, such as moss. A stake drainage feature 11 is within the stake to allow liquid to drain from within Totem and into the growth material. The plant support pole 2 is attached to the base stake 1 via various methods. The pole is a modular extension of any shape, such as cylindrical, tubular, tube-shaped, rod-shaped, honeycomb, octagon, spiral, or the like. In an aspect, fluid, soil, fertilizer, moss, or other material may be poured in the openings. The pole may also be ornate. It interlocks with the stake, to be described later. The pole has porous openings 13 that may form breathable holes, or vented open shapes, of any form, to allow for airflow and exposure to the internal substrate for growth attachment. The pole contains an area for branding of logo, 14. The pole may also be capped by cap 20. The cap 20 may include a series of holes 22. In some example embodiments, the holes may be of a similar shape to the holes in the pole. For example, the holes in the pole may be circular, triangular, square, hexagonal, shaped like a pentagon, a heptagon, an octagon, a nonagon, a polygon having more than nine sides, or shaped like an irregular shape.

The cap 20 may also provide a method of adding water or other fluids to any material that may be within the Totem plant support. For example, in one embodiment, fluid may be poured directly through the holes in the cap 20.

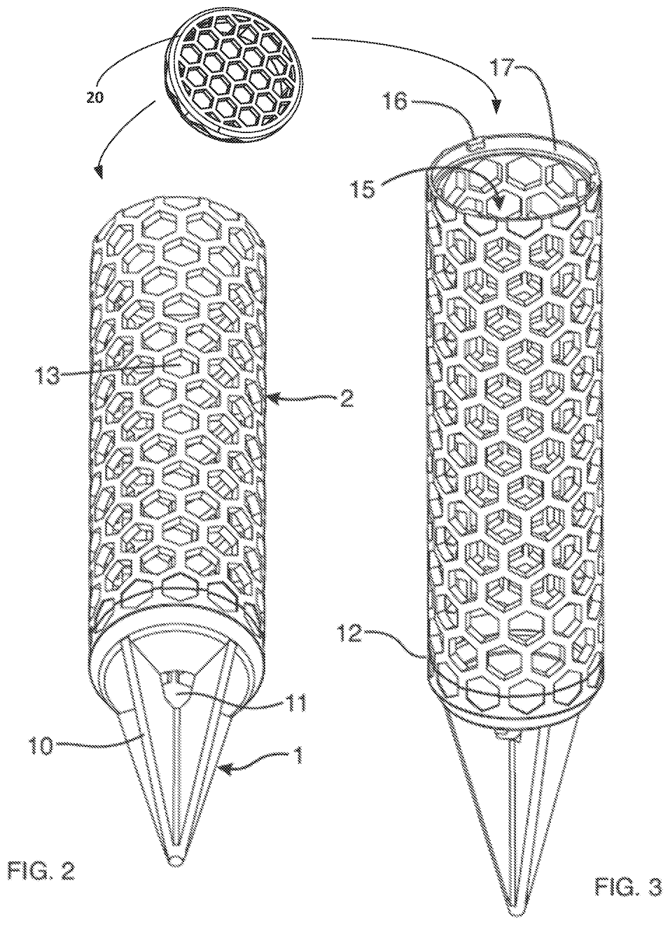

FIG. 2 is an illustration showing the assembled Totem from the bottom of the base stake 1. This view illustrates more detail of the ribs 10 and the stake drainage feature 11. Ribs 10 may run from the attachment point to the pole 2. Ribs 10 may generally be parallel to the pole 2.

In an example embodiment, the stake 1 may have a functional design for stability to secure the assembly in soil or other material. In an example embodiment, the pole 2 may be a porous cylindrical body. In an example embodiment, the pole 2 may allow maximum airflow for roots to attach. In an example embodiment, the stake rib 10 may be for insertion and support. In an example embodiment, the stake drainage 11 may allow fluid to drain from pole and substrate. The systems and methods described herein may bring moisture, food, or both moister and food up to the filling material, and air roots. The example embodiment illustrates the mating connection point 12 for stake 1 and pole, and pole 2 to pole(s) segments. In some embodiments, the connecting system that couples components together, e.g., such as an interlocking mechanism, may accommodate other devices. For example, the interlocking mechanism may allow a pole to be coupled to a flat stand. The flat stand may be placed on a solid surface, e.g., cement, countertop, bench, soil. In another embodiment, a flat surface may be placed in container with fluid. This allows for plant clippings to produce roots. Material can be contained in the pole underwater portion, to assist in root growth. Later, the assembly can be embedded in soil or substrate material. In some examples, a mid-flange may be used for mounting, coupling, or partitioning.

The pole 2 may have a plurality of porous opening 13 on the pole 2. The porous opening 13 may provide for airflow and roots to attach.

An example embodiment may include a branding location 14. The branding location 14 may be an area where a product's brand could be placed. For example, the branding location 14 may be a flat area in which it may be capable of receiving a sticker with the corporate logo, paint-related to the corporate logo, or other identifying information. The poles 2 may have a fill area 15 for moss or another substrate.

FIG. 3 is an illustration showing the assembled Totem from the top of a plant support pole 2, assembled to the base stake 1. The figure illustrates how the moss or other substrates can be inserted into an internal filling volume 15, into the plant support pole 2, as well as a connection area 17, and interlocking mechanism 16, for added poles to generate height as the plant grows.

The interlocking mechanism 16 may securely keep a secure connection for the stake to pole and pole to pole(s) connections. The connection area 17 for receiver may allow for stake-to-pole or pole-to-pole(s) connections. In another embodiment, the connecting area 17 may be a connection point for any other feature currently known or later developed such as a mid-flange for mounting.

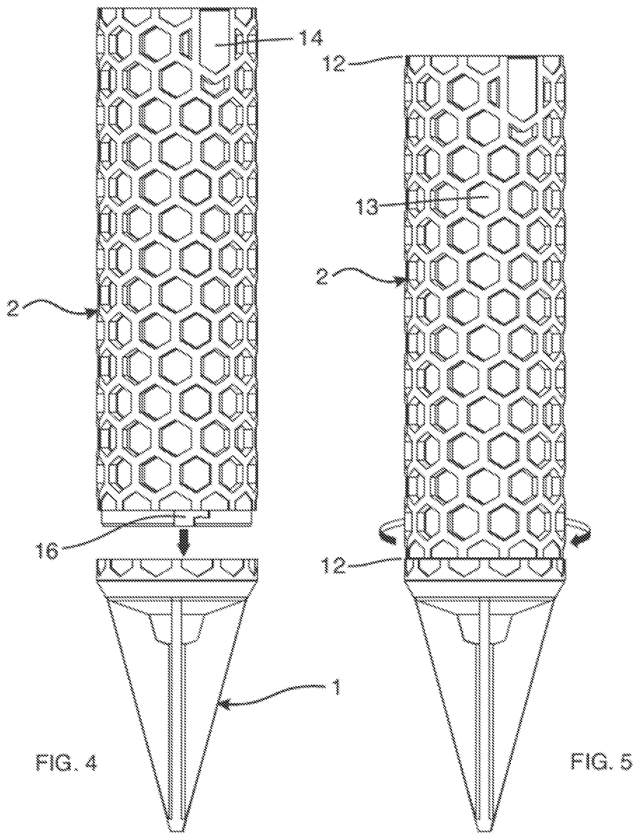

In FIG. 4, the plant support pole 2, interlocking mechanisms 16, such as slots, may be aligned with the stake interlocking tabs, and the pole may be inserted into the stake. The close fit connection area 17 aligns the mating segments.

In FIG. 5, the plant support pole 2 may be rotated to lock it in place with the base stake 1. This interlocking mechanism may allow each subsequent pole segment to be locked in for stability. This connection and registration and locking mechanism are one of many that may be utilized. Other methods such as screw, snap, and clip can be implemented.

FIG. 6 is a section view of the assembly, further illustrating the primary connections at connection area 17 and interlocking mechanisms 16, not only to the stake but also for additional plant support pole(s) (not shown) the same or similar to plant support pole 2.

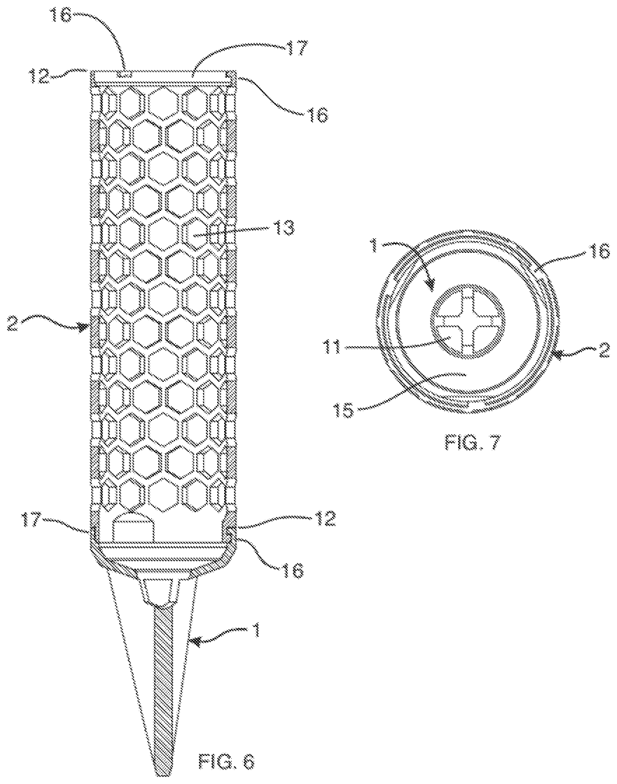

FIG. 7 is a top view of the assembly. The plant support pole 2 can be seen on the outer perimeter, with the base stake 1 below. This view illustrates the internal filling volume 15, area for moss or other substrates. The stake drainage feature 11 can be seen in the center. The internal filling volume 15, area for moss or other substrates may be filled or left empty. The moss or other substrates may retain water and nutrients that may be useful to the plants.

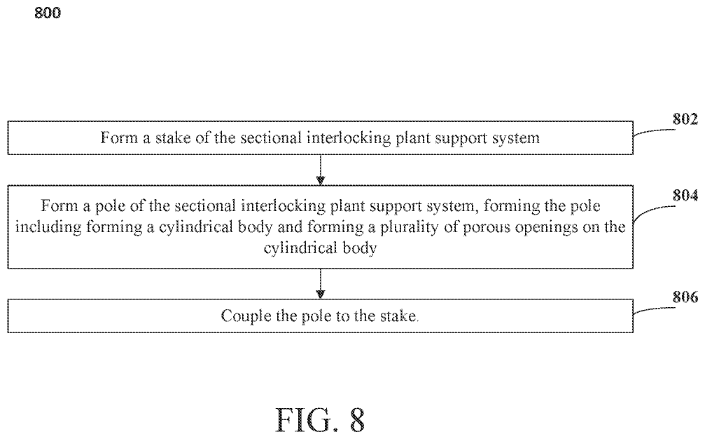

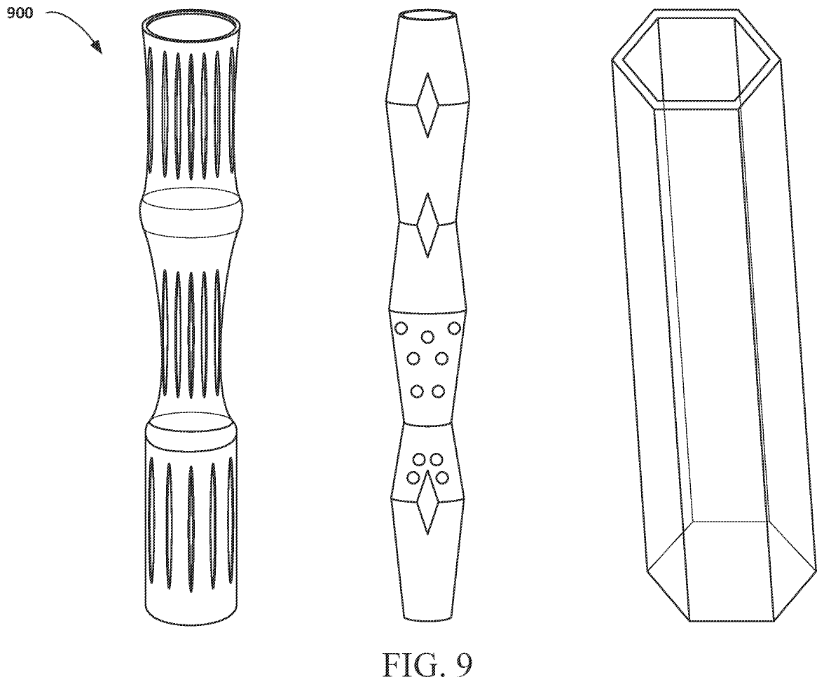

FIG. 8 is a flow diagram illustrating an example method 800 in accordance with the systems and methods described herein. The method 800 may be a method of forming a sectional interlocking plant support system. Additionally, the method 800 may include forming a stake of the sectional interlocking plant support system 802. The method 800 may also include forming a pole of the sectional interlocking plant support system, forming the pole, including forming a cylindrical body, and forming a plurality of porous openings on the cylindrical body 804. The method 800 may include coupling e.g., interlocking, joining, linking, connecting, engaging, etc. the pole to the stake 806. For example, the pole to the stake 806 connect at complimentary ends of the pole and the stake 806 that may be configured to fit together. In an example, the complimentary ends of the pole and the stake 806 that may be configured to fit together may be configured to interlock. In some examples, a cap may be installed on the pole, e.g., opposite the stake.

FIG. 9 is a diagram illustrating example pole shapes 900. The example pole shapes 900 include non-cylindrical shapes. For example, pole shapes may be octagons, pentagons, or other shapes. In other words, the shape of a cross-section of the pole may be an octagon, a pentagon, or other shapes. It will be understood that in some embodiments, the pole shape may have a circular cross-section, and the pole may generally be cylindrical. In another embodiment, the pole may be tubular.

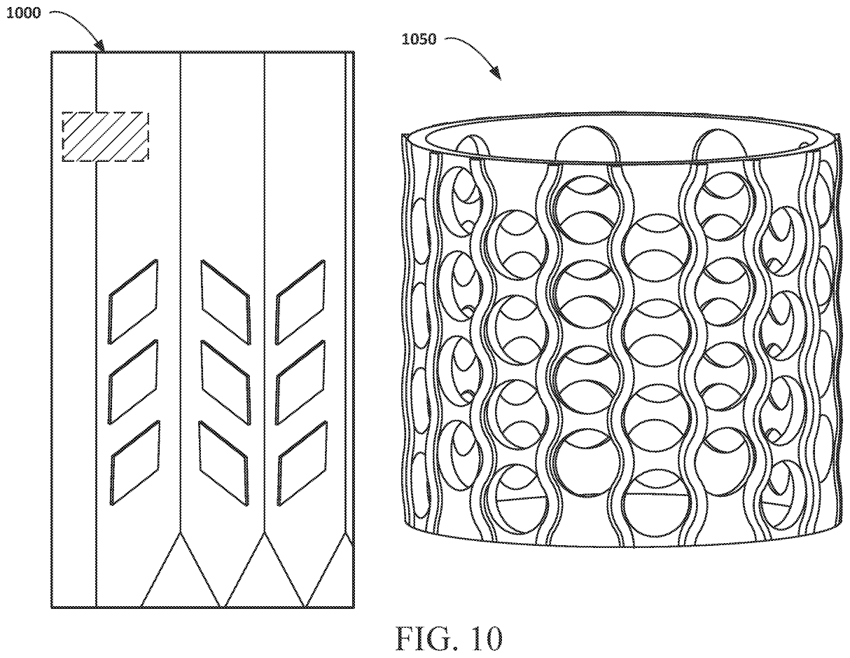

FIG. 10 is a diagram illustrating example air hole shapes for an example pole. The design of the air holes may be almost any size and shape. The porous openings may be a parallelogram shape in the example 1000. In the illustrated example, a number of parallelogram-shaped openings may be formed on the side of a pole. In another illustrated example 1050 of FIG. 10, the air holes or porous openings may be circular in shape. In the example, a number of circles may form rows on the pole. In the illustrated example 1050, alternating rows of circular air holes or porous openings may be offset from each other. The rows of holes may also be separated from each other by a series of wavy lines formed in the material of the pole.

In an aspect, the stake may further include a rib. In an aspect, the stake may further include a drain. In an aspect, the stake and the pole may meet at a connection area. In an aspect, the pole and a second pole meet at a connection area. In an aspect, the sectional interlocking plant support system further includes a branding location on the pole. In an aspect, the pole forms a fill area.

In an aspect, the sectional interlocking plant support system further includes a pole mating connection point for a stake-to-pole segment, the pole mating connection point including an interlocking mechanism.

In an aspect, the sectional interlocking plant support system further includes a stake mating connection point for a stake-to-pole segment; the pole mating connection point may include a second interlocking mechanism configured to connect to the interlocking mechanism of the pole mating connection point.

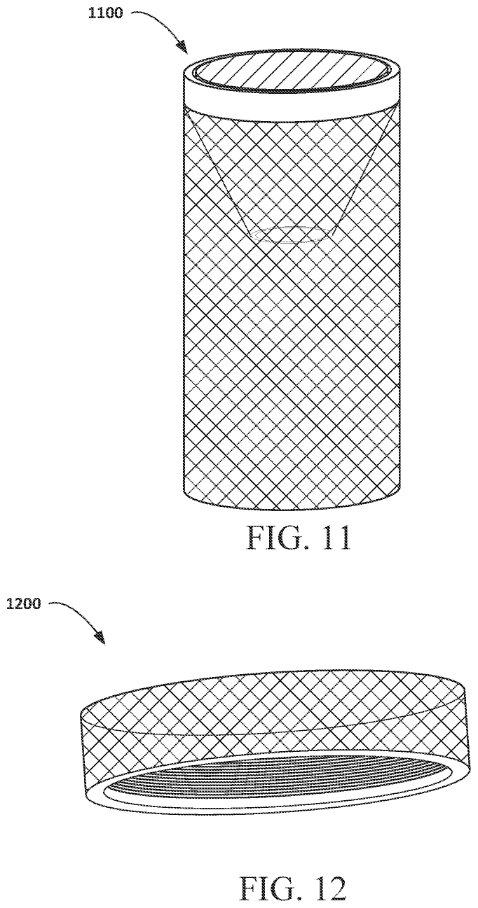

Reference to FIGS. 11-12, in an aspect, one of the interlocking mechanism and the second interlocking mechanism includes a funnel connection point and another of the interlocking mechanism, and the second interlocking mechanism includes a conical connection point configured to mate with the funnel connection point. The funnel may also be used to add material to the stake. For example, the funnel may also be used to add fluid, water, fertilizer, moss, soil, or other material.

In an aspect, the one of the interlocking mechanism and the second interlocking mechanism includes a screw connection point and another of the interlocking mechanism, and the second interlocking mechanism includes a conical connection point configured to mate with the screw connection point.

In an aspect, the sectional interlocking plant support system further includes a second pole having a second pole mating connection point for a pole-to-pole segment, the second pole mating connection point including a second interlocking mechanism configured to connect to the interlocking mechanism of the pole mating connection point.

In an aspect, the one of the interlocking mechanism and the second interlocking mechanism includes a funnel connection point and another of the interlocking mechanism, and the second interlocking mechanism includes a conical connection point configured to mate with the funnel connection point.

In an aspect, the one of the interlocking mechanism and the second interlocking mechanism includes a first screw connection point and another of the interlocking mechanism, and the second interlocking mechanism includes a second screw connection point configured to mate with the first screw connection point.

In an aspect, the porous openings on the pole including at least one hole shaped in at least one of a circle, a triangle, a square, a hexagon, a pentagon, a heptagon, an octagon, a nonagon, a polygon having more than nine sides, or an irregular shape.

FIG. 11 is a diagram illustrating an example locking mechanism 1100 for the systems and methods described herein. In the illustrated example, one of the locking mechanisms may be shaped like a funnel. The funnel-shaped locking mechanism may be configured to receive a generally conically shaped locking mechanism. For example, one end of a pole may have the funnel-shaped locking mechanism, while the other end of the pole may have the generally conically shaped locking mechanism. Accordingly, a conically shaped locking mechanism on one pole may be inserted into a funnel-shaped locking mechanism on another pole. The locking mechanism may then connect the poles.

In an example embodiment, a base stake may have a conical-shaped locking mechanism or a funnel-shaped locking mechanism. In an example of a base stake with a conically shaped locking mechanism, the base stake may be coupled to an end of a pole with a funnel-shaped locking mechanism. Conversely, in an example with a base stake having a funnel-shaped locking mechanism, the base stake may be coupled to a pole at the end of the pole with a conically shaped locking mechanism.

FIG. 12 is a diagram illustrating an example locking mechanism 1200 for the systems and methods described herein. As illustrated, a screw-top locking mechanism may be used in some embodiments. In one example, one end of a pole may have male threads, and another end of the pole may have female threads. Accordingly, two poles may be connected together, male end to female end.

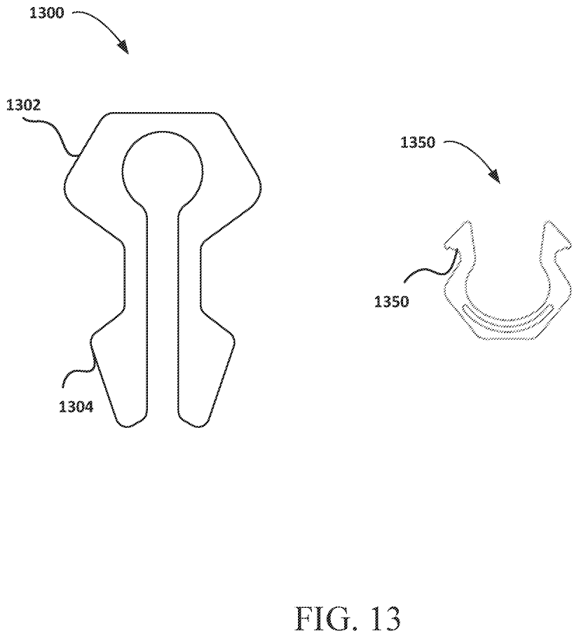

FIG. 13 is a diagram illustrating example pole clips 1300, 1350 for the systems and methods described herein. The pole clips 1300, 1350 may be configured to connect to holes in, for example, a pole, e.g., the plant support pole 2 of FIGS. 1-7. The holes in the pole may have a secondary purpose, the connection of accessories. In some examples, the clip may be used to hold a plant. For example, the clips 1300 may lock to a pole at 1304, 1354. A plant stem may extend through an opening 1302 in the clip 1300. In other examples, the clip 1300 may be used to hold a stake extension post. The clip 1300 may also hold an air root ball. In some examples, the clip 1300 may be used to hold VELCRO or a rubber strap to the pole. In some embodiments, clips may be used as spacer hooks or to stabilize one pole to the next.

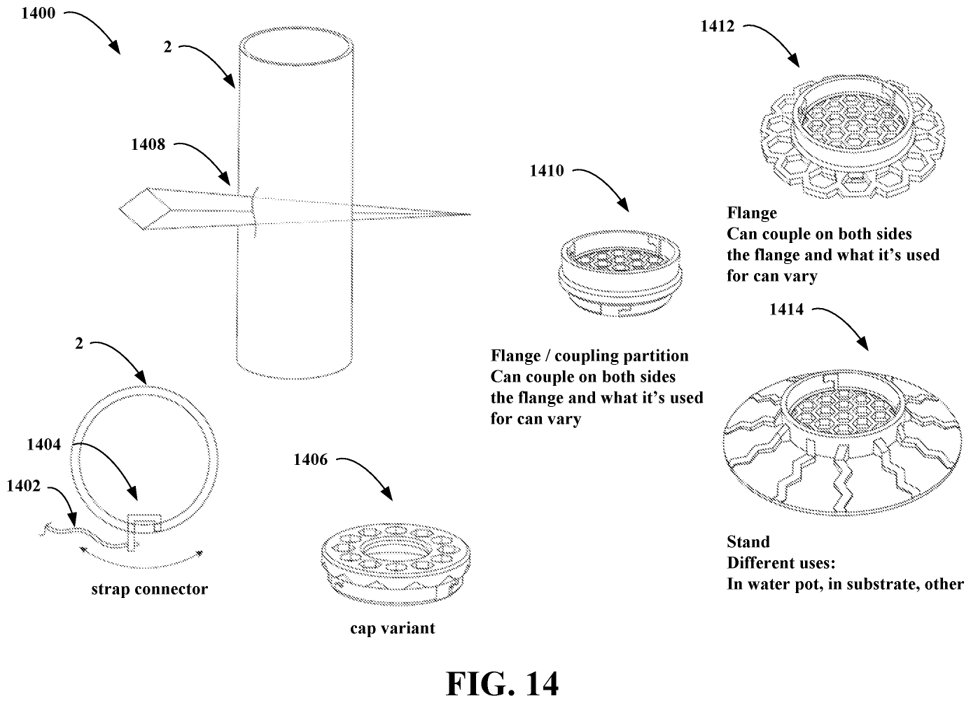

FIG. 14 is another diagram illustrating examples 1400 of devices that may be used in conjunction with the pole 2 or other components of the systems and methods described herein. Pole holes may have a secondary purpose. The secondary purpose may be to connect accessories. In one example, an accessory may clip onto a pole at one of the plurality of holes in the pole to hold a plant. An example accessory may clip onto a pole at one of the plurality of holes in the pole to hold a stake extension post. In another example and accessory may clip onto a pole at one of the plurality of holes in the pole to hold an air root ball. Additionally, an accessory may clip to attach Velcro or a rubber strap. An example of a rubber stretch material 1402 and a strap connector 1404 are illustrated in FIG. 14. An example cap 1406 is also illustrated in FIG. 14. The cap may couple to a pole 2, e.g., opposite stake 1. The pole 2 may receive the pin 1408 which may aid in supporting a plant, e.g., by supporting a tie to the plant.

FIG. 14 also illustrates flanges 1410, 1412. The flanges 1410, 1412 may couple to the pole 2. In an embodiment, the flange 1410, 1412 may couple to either end of the pole 2. In other words, the type of connection between the flange 1410, 1412 may be the same. One flange 1410, 1412 may couple to one end of the pole 2 and another flange 1410, 1412 may couple to another end of the pole. In another embodiment, the flange may couple to one end of the pole 2 and another type of flange 1410, 1412 may couple to another end of the pole 2. The flanges 1410, 1412 may be used on one end of the pole 2 while a stand 1414 may be used on another end of the pole 2. In some embodiments, the stand 1414 may couple to an end of the pole 2. The other end of the pole 2 may couple to a second pole 2. Another end of the second pole 2 may couple to the flange 1410, 1412 or a cap 20, 1406. It will be understood that the components may be mixed and matched in a number of different ways, e.g., by the gardener or plant enthusiast.

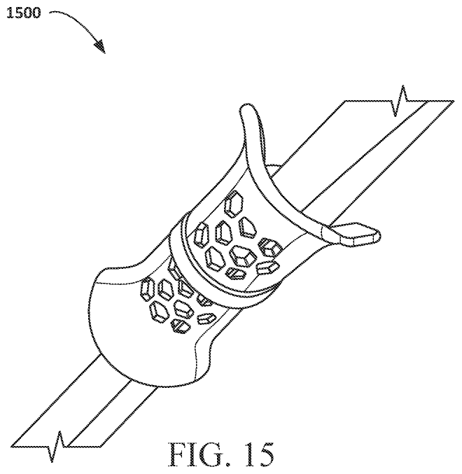

FIG. 15 is a diagram illustrating an example branch brace 1500 in accordance with the systems and methods described herein. The example branch brace 1600 may also include a series of holes. The branch brace 1500 may act as a support and may be used to hold up a branch. An example may include options for a cabling device. For example, a brace 1500 may need to have a strap or cabled attached to it to manipulate the branch or leaf position. Thus, a strap or cable may be attached or go around the brace 1500 and attached to some other point to manipulate the position of the plant. For example, the strap may be connected to the ground, a fence, a post, or other location. The brace 1500 may spread out the pressure exerted by the strap or cable. Spreading out the pressure may make it less likely for the strap or cable to damage the plant that the brace 1500 is installed on.

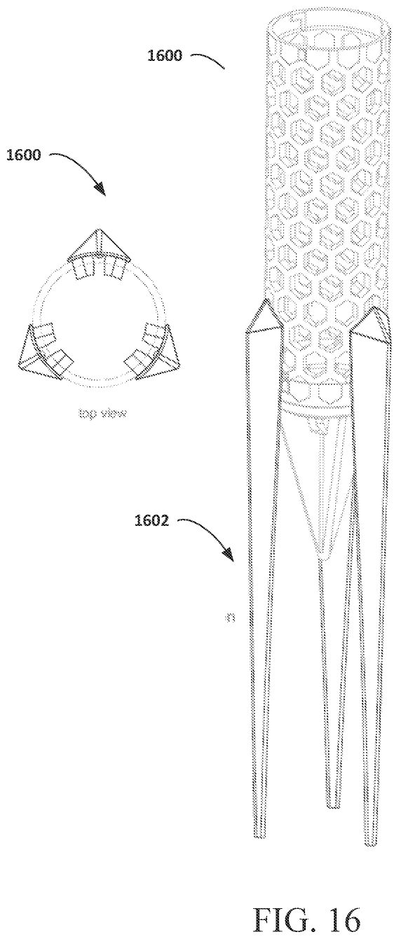

FIG. 16 is a diagram illustrating an example external support extender 1600 in accordance with the systems and methods described herein. The external support extender 1600 may be a pin, peg, dowel, hook, bolt, or other structure 1602 that may be installed through a hole in the pole and may extend from the pole. The external support extender 1700 may act as a stabilizer or as a surface on which a leaf or vine may be able to climb. In other examples, support extenders may include a clip similar to the clip of FIG. 13. For example, a clip similar to the clip 1300 of FIG. 13 may fasten into a pole. A support structure may extend out from the clip and out from the poll.

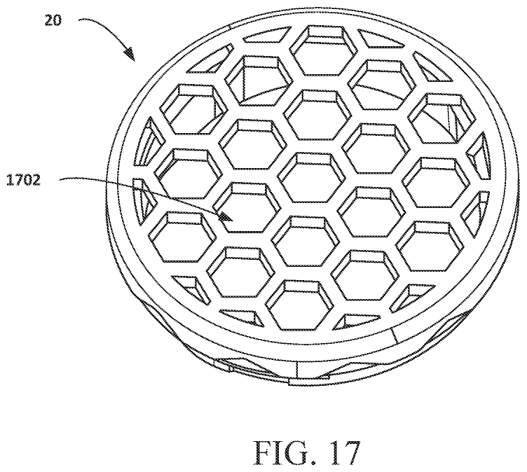

FIG. 17 is a diagram illustrating an example cap 20 in accordance with the systems and methods described herein. The cap 20 may include a series of holes. In some example embodiments, the holes 1702 may be of a similar shape to the holes in the pole. For example, the holes in the pole may be circular, triangular, square, hexagonal, shaped like a pentagon, a heptagon, an octagon, a nonagon, a polygon having more than nine sides, or shaped like an irregular shape.

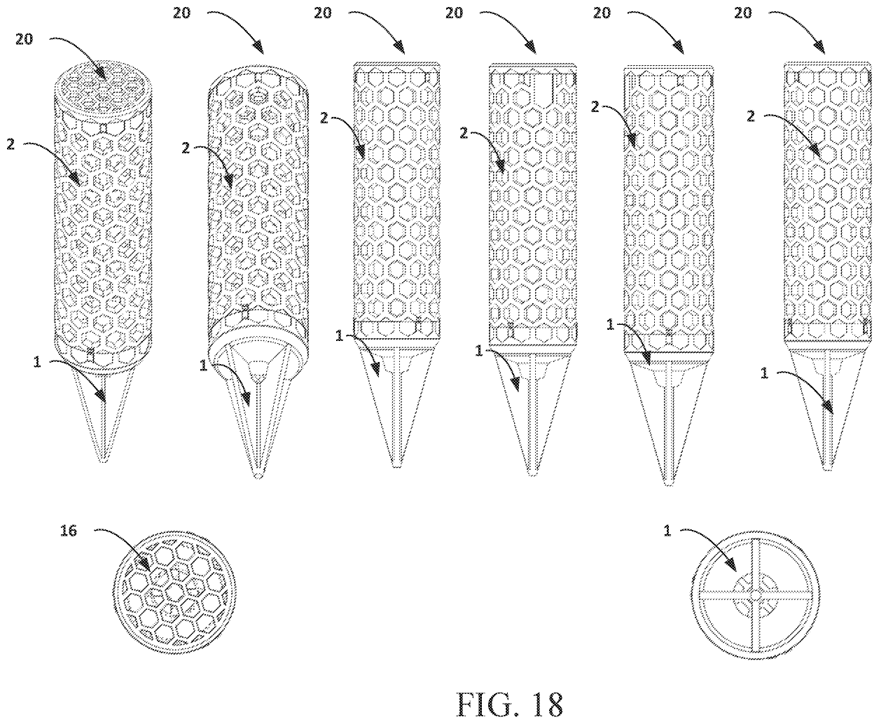

FIG. 18 is a diagram illustrating the example assembled stake 1 and one pole 2 of FIGS. 1-7 and the cap 20 of FIG. 17, with the cap 20 installed on the pole 2. The cap 20 may seal or partially seal the end of the plant support. In other words, the cap 20, the pole 2, and the stake 1 may form a container for the moss (or other material as discussed and described herein). The container formed might hold the moss or other material despite being porous. The volume of moss (or other material) held may be increased by using additional poles 2. In some examples the cap 20 may not be installed. however.

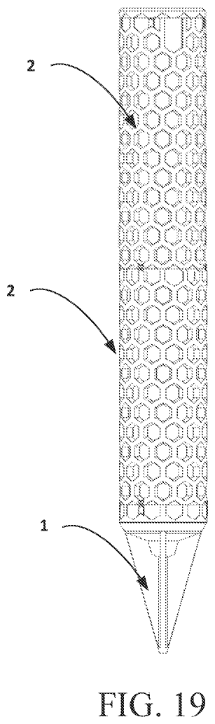

FIG. 19 is a diagram illustrating a stake 1 and two poles 2. Accordingly, the systems and methods described herein illustrate examples of a stake 1 and one pole 2 (FIGS. 1-7 and 18) and a stake one and two poles 2 (FIG. 19). It will be understood by those of skill in the art that these are example embodiments. In other example embodiments three or more poles 2 may be used. By using more poles 2 a taller plant support may be generated. Accordingly, the number of poles 2 used maybe related to the size of the plant to be supported. In general, taller plants might use more poles 2. It will be understood, however that in some embodiments the length of the poles may vary. Accordingly, there is generally not a specific number of poles for a specific height desired. There may be, however, a specific number of poles for a particular height for a given length of pole. This does not mean, however that the length of poles cannot be mixed and matched. In other words, a poll of one length may be used with a pole or poles of another length. Generally, the poles may need to be the same diameter or the same shape and size in cross section. However, in some embodiments adapters between sizes may be used. Furthermore, in general, the size of any of the stake 1, the pole 2, or the cap 20 may vary. Generally, the size of any of the stake 1, the pole 2, and the cap 20 may each vary from embodiment to embodiment such that, within a particular embodiment, the stake 1, the pole 2, and the cap 20 may be coupled together as described herein. As described herein, however, adapters may also be used, e.g., to connected different size poles 2 together.

Furthermore, while the example FIG. 19 (as well as the examples of FIGS. 1-7 and 18) includes the stake 1, it will be understood that other configurations are possible. For example, a flat stand may be used in place of the stake 1 so that the plant support may be used in other configurations such as on cement next to a planter (or other container or pot). In other embodiments, however, the stake 1 might be used in an example with a planter. for example, the stake 1 might be placed into soil within the planter and the assembly including the stake 1 and the poles 2 may support one or more plants in the planter (or other container or pot).

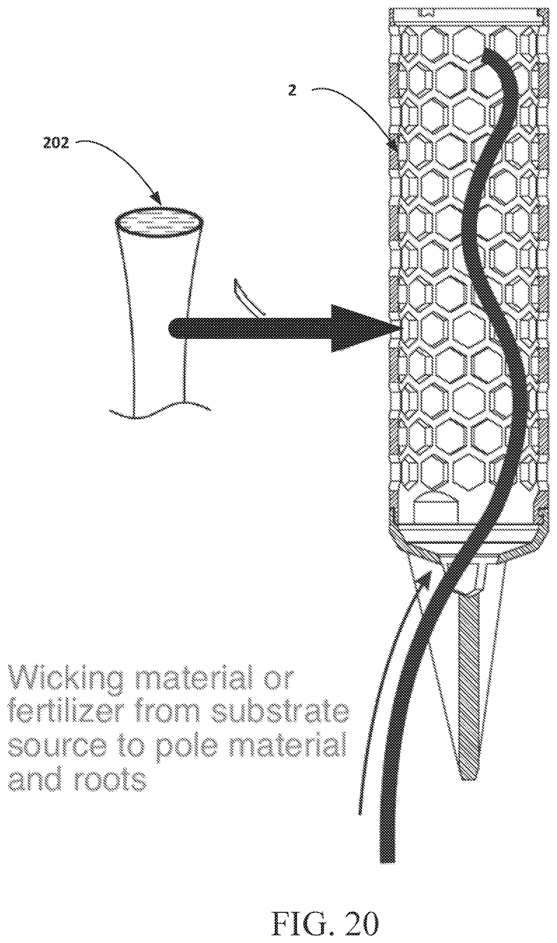

FIG. 20 is a diagram illustrating a wicking material or fertilizer 202 in a pole 2. The wicking material or fertilizer 202 (or both) may be from a substrate source. The wicking material or fertilizer (or both) may be in the pole 2 with plant roots, soil, moss, and/or other material. The wicking material, fertilizer, plant roots, soil, moss, and/or other material may be contained within the pole 2 by the porous structure of the pole 2 and the stake 1 or other ends that may be placed on the pole 2, e.g., such as caps 20, 1406, stands 1414, flanges 1410, 1412, etc.

One or more of the components, steps, features, and/or functions illustrated in the figures may be rearranged and/or combined into a single component, block, feature, or function or embodied in several components, steps, or functions. Additional elements, components, steps, and/or functions may also be added without departing from the disclosure. The apparatus, devices, and/or components illustrated in the figures may be configured to perform one or more of the methods, features, or steps described in the figures.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

The foregoing description of the embodiments of the present invention has been presented for the purposes of illustration and description. It is not intended to be exhaustive or to limit the present invention to the precise form disclosed. Many modifications and variations are possible in light of the above teaching. It is intended that the scope of the present invention be limited not by this detailed description, but rather by the claims of this application. As will be understood by those familiar with the art, the present invention may be embodied in other specific forms without departing from the spirit or essential characteristics thereof. Likewise, the particular naming and division of the modules, routines, features, attributes, methodologies and other aspects are not mandatory or significant, and the mechanisms that implement the present invention or its features may have different names, divisions and/or formats.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

1. A sectional interlocking plant support system providing a stand for supporting growing plants in soil comprising:
a stake; and
a pole, coupled to the stake, the pole comprising a porous tubular body, the porous tubular body formed by a plurality of porous openings on the pole, the pole configured to be stackable on another pole, height of the sectional interlocking plant support system being adjustable by connecting a number of poles together.

2. The sectional interlocking plant support system of claim 1, wherein the stake further comprises a rib.

3. The sectional interlocking plant support system of claim 1, wherein the stake further comprises a drain.

4. The sectional interlocking plant support system of claim 1, further comprising a pole mating connection point for a stake-to-pole segment, the pole mating connection point comprising an interlocking mechanism.

5. The sectional interlocking plant support system of claim 4, further comprising a stake mating connection point for a stake-to-pole segment, the pole mating connection point comprising a second interlocking mechanism configured to connect to the interlocking mechanism of the pole mating connection point.

6. The sectional interlocking plant support system of claim 5, wherein the stake and the pole meet at a connection area.

7. The sectional interlocking plant support system of claim 6, wherein the one of the interlocking mechanism and the second interlocking mechanism comprises a funnel connection point and another of the interlocking mechanism and the second interlocking mechanism comprises a conical connection point configured to mate with the funnel connection point.

8. The sectional interlocking plant support system of claim 6, wherein the one of the interlocking mechanism and the second interlocking mechanism comprises a screw connection point and another of the interlocking mechanism and the second interlocking mechanism comprises a conical connection point configured to mate with the screw connection point.

9. The sectional interlocking plant support system of claim 4, further comprising a second pole having a second pole mating connection point for a pole-to-pole segment, the second pole mating connection point comprising a second interlocking mechanism configured to connect to the interlocking mechanism of the pole mating connection point.

10. The sectional interlocking plant support system of claim 5, wherein the pole and a second pole meet at a connection area.

11. The sectional interlocking plant support system of claim 10, wherein the one of the interlocking mechanism and the second interlocking mechanism comprises a funnel connection point and another of the interlocking mechanism and the second interlocking mechanism comprises a conical connection point configured to mate with the funnel connection point.

12. The sectional interlocking plant support system of claim 10, wherein the one of the interlocking mechanism and the second interlocking mechanism comprises a first screw connection point and another of the interlocking mechanism and the second interlocking mechanism comprises a second screw connection point configured to mate with the first screw connection point.

13. The sectional interlocking plant support system of claim 1, further comprising a branding location on the pole.

14. The sectional interlocking plant support system of claim 1, the pole forming a fill area.

15. The sectional interlocking plant support system of claim 1, the porous openings on the pole comprising at least one hole shaped in at least one of a circle, a triangle, a square, a hexagon, a pentagon, a heptagon, an octagon, a nonagon, a polygon having more than nine sides, or a repeating irregular shape.

16. The sectional interlocking plant support system of claim 1, further comprising a cap coupled to the pole opposite the stake.

17. A method of a forming a sectional interlocking plant support system, the method comprising:
forming a stake of the sectional interlocking plant support system;
forming a pole of the sectional interlocking plant support system, forming the pole including forming a tubular body and forming a plurality of porous openings on the tubular body; and
coupling the pole to the stake.

18. A sectional interlocking plant support system providing a stand for supporting growing plants in soil comprising a pole comprising:
a porous tubular body, the porous tubular body formed by a plurality of porous openings on the pole, the plurality of porous openings including number of pentagonal openings, the pole configured to be stackable on another pole, height of the sectional interlocking plant support system being adjustable by connecting a number of poles together.
